(19) United States
(12) Patent Application Publication
(10) Pub. No.: US 2010/0251905 A1
(43) Pub. Date: Oct. 7, 2010

(54) FEED SYSTEM FOR MULTIPLE-TIER BAKING OVEN

(76) Inventors: Ottmar Baumeister, Arnstein-Buchthold (DE); Bernd Marx, Arnstein (DE); Oliver Mühl, Neunkirchen (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/450,648

(22) PCT Filed: Mar. 27, 2008
(86) PCT No.: PCT/EP2008/053643

§ 371 Date: Jun. 14, 2010

(30) Foreign Application Priority Data
Apr. 5, 2007 (DE) 10 2007 016 931.2

(51) Int. Cl. A21B 1/42

(52) U.S. Cl. 99/443 R

(57) ABSTRACT

A feed installation for arrangement in front of at least one multi-tier baking oven having a plurality of hearths provides for increased flexibility. The feed installation includes a pull-out frame with carrier elements for receiving and supporting a pull-out hearth. The feed installation further includes a baking item receiving device having a baking item receiving surface for receiving baking items arranged on a baking surface and which is movable relative to the baking surface. Methods of feeding a multi-tier baking oven having baking surfaces arranged on pull-out hearths with baking items using the feed installation are also provided.

The invention concerns a feed installation for arrangement in front of at least one multi-tier baking oven having a plurality of hearths.

DE 100 29 382 B4 and DE 196 51 332 C2 disclose baking ovens with pull-out hearths for receiving baking items, wherein the pull-out hearths are movable out of the baking oven through closable openings for loading purposes and are movable into the baking oven for the baking operation. Such baking ovens require manual charging of the pull-out hearths, for is example with freely displaced baking items, or require charging with baking items which are disposed in moulds by way of loading apparatuses such as cranes or the like.

DE 10 2006 008 153 A1 discloses an apparatus for loading and unloading a baking oven with a displaceable treatment table and a conveyor cloth. The conveyor cloth forms the top side of the treatment table, is passed around at least one direction-changing edge of the treatment table and is drivable. Such apparatuses are sold by the applicants under the name ‘athlet’.

The invention is based on the problem of increasing the flexibility of a feed installation.

According to the invention that problem is solved by the features of claim 1.

The invention concerns a feed installation for arrangement in front of a multi-tier baking oven having a plurality of hearths with baking surfaces, wherein the term baking surfaces is used to denote both fixedly installed baking surfaces and also ‘mobile’ baking surfaces, that is to say which are formed by pull-out hearths. A feed installation according to the invention has in particular the following features:

a) a pull-out frame with carrier elements for receiving and supporting pull-out hearths, and

b) a baking item receiving device having a baking item receiving surface which for receiving baking items arranged on a baking surface is movable relative to the baking surface.

Therefore not just hearths with fixedly installed baking surfaces but also pull-out or extendable hearths as well as combination hearths can be charged with a feed installation according to the invention. In this connection the term combination hearth is used in particular to denote hearths which have both fixedly installed baking surfaces and also pull-out hearths. The invention therefore affords new options in terms of feed technology. A very simple embodiment of the feed installation according to the invention is described hereinafter to illustrate the invention.

In a very simple embodiment a feed installation according to the invention has a pull-out frame arranged in front of a baking oven with at least one pull-out hearth in such a way that finished baked products—lying on the pull-out hearth—can be pulled in one plane out of the hearth on to the carrier elements. In addition, in this simple embodiment, the feed installation according to the invention has a baking item receiving surface which is independent of the pull-out frame and which is arranged above or beneath the pull-out frame in such a way that the baking items arranged on the baking surface can be received by a relative movement between the baking item receiving surface and the baking surface. The baking item receiving surface can be for example a metal sheet with a very thin front edge which is moved at a very shallow angle under the baking items to receive baking items and which pushes the baking items into the depth of the baking oven by a substantially translatory movement. With the above-described simple embodiment of a feed installation according to the invention a multi-tier baking oven having at least one fixed hearth with a stationary baking surface and at least one baking surface arranged on a pull-out hearth can be fed by machine. In that respect the term feed is used to denote both loading and also unloading of a hearth. The loading operation takes place in the reverse sequence to the unloading operation described above.

In a practical embodiment of the feed installation according to the invention the pull-out frame has a first transport mechanism with a first coupling device, wherein the transport mechanism is adapted to convey a pull-out hearth out of a hearth of a multi-tier baking oven on to the carrier elements. Such a transport mechanism is suitable in particular for auto-mated and possibly computer-controlled inward and outward movement of pull-out hearths.

If the pull-out frame and the baking item receiving surface are displaceable in respect of height, the feed installation according to the invention can be used for multi-tier baking ovens having a plurality of mutually superposed hearths—also of differing types. Then both fixedly installed hearths with stationary baking surfaces and also at least one pullout hearth can be provided on the standing placement surface of a known multi-tier baking oven, and jointly fed with an apparatus according to the invention. On the one hand that saves on standing placement surface and in addition the investment costs for a second feed installation are avoided.

To ensure that the pull-out frame and the baking item receiving surface are not actuated simultaneously, which is not wanted, so that they suffer damage, a development of the feed installation according to the invention provides a control unit with which the operating condition of the pull-out frame and the operating condition of the baking item receiving surface can be monitored and controlled.

In accordance with a further embodiment the baking item receiving surface is formed by a conveyor cloth which is guided around at least one direction-changing edge extending transversely with respect to the pull-out direction, and which is drivable. Such a conveyor cloth is described for example in DE 10 2006 008 153 A1. In connection with the feed installation according to the invention it has the advantage that the baking items to be loaded and unloaded can be particularly carefully deposited by the drivable direction-changing edge from the baking item receiving surface on to the baking surface and can be pushed on to the baking item receiving surface from the baking surface respectively.

It is further advantageous if the pull-out frame and the baking item receiving surface are both mounted on a common lift axis. In that way the structural and production-engineering complication and expenditure for manufacture of a feed installation according to the invention can be kept down. Furthermore already existing feed installations can possibly be converted to a feed installation according to the invention by replacement and/or addition of components.

If the pull-out frame and the baking item receiving surface are both mounted to the same lift axis, there are essentially two possibilities regarding the arrangement of the pull-out frame and the baking item receiving surface to the lift axis.

In accordance with a first possible option the pull-out frame and the baking item receiving surface are mounted to a common height-adjustable displacement unit of the lift axis. That has the advantage that only one displacement unit and only one main drive for height adjustment are required for the pull-out frame and the baking item receiving surface. That reduces the manufacturing costs and saves on structural space and weight. A further advantage of this option is that existing feed installations can be converted to feed installations according to the invention at low cost.

In accordance with a second possible option the pull-out frame and the baking item receiving surface are mounted to two separate displacement units of the lift axis. That is advantageous in particular when there is sufficient space for the feed installation and hearths at various heights are to be simultaneously operable with the feed installation. That is necessary in particular in the case of very high multi-tier baking ovens having a multiplicity of mutually superposed hearths which are operated with a high degree of utilisation.

In a further practical embodiment of the feed installation according to the invention the pull-out frame and the baking item receiving surface are height-adjustable relative to each other. By virtue of that functional development the relative movement between the baking item receiving surface and the baking surface can also be achieved by the baking item receiving surface being at rest and a baking surface disposed on a pull-out hearth being moved relative to the baking item receiving surface. That can be implemented for example if the baking item receiving surface is moved into a position directly above the pull-out frame so that it is precisely still possible for a pull-out hearth to be pulled through by way of the pull-out frame under the baking item receiving surface. The baking items on the baking surface of the pull-out hearth are then inevitably pushed on to the baking item receiving surface by virtue of the baking item receiving surface pushing under them. The baking items are dealt with particularly carefully if the baking item receiving surface is formed by a conveyor cloth driven at the same speed as that at which the pull-out hearth is pulled out of the hearth. In that case the baking items are picked up from the baking surface by the conveyor cloth. That is also referred to in the terminology in the art as ‘scrabbling up’ baking items.

Particularly if the pull-out frame and the baking item receiving surface are displaceable in respect of height relative to each other, it is advantageous if the control unit is adapted to control the operating condition of the baking item receiving surface in dependence on the operating condition of the pull-out frame. For, while for example baking items are scrabbled up from a pull-out hearth with a feed installation according to the invention, the pull-out frame involved in that operation and the baking item receiving surface are not available for other tasks. It is therefore advantageous if by means of the control unit, the system ensures that further tasks are per-formed by the participating ones of the feed installation elements (that is to say pull-out frame and baking item receiving surface), only when the elements are available again and their operating condition therefore allows that.

It is not necessary for the pull-out frame and the baking item receiving surface which is independent of the pull-out frame both to be mounted to the same lift axis. It is also possible for the baking item receiving surface to be a constituent part of a separate treatment table arranged spatially beside the pull-out frame. In this connection the expression ‘beside the pull-out frame’ is used to denote both a lateral arrangement of a treatment table and also an arrangement behind the feed apparatus. This embodiment is admittedly only suitable for loading and unloading hearths, provided with pull-out hearths, of a multi-tier baking oven. As baking items of all kinds can be arranged on baking surfaces of pull-out hearths, that however is not a disadvantage.

In a practical development the treatment table is adapted to displace the baking item receiving surface in the pull-out direction to such a degree that the baking item receiving surface and the surface of the pull-out frame are at least partially arranged one over the other. In that case—as already described in relation to the above-described embodiment with pull-out frame and baking item receiving surface on a lift axis—loading or unloading of the baking item receiving surface can be effected by the baking item receiving surface being moved over the baking surface and by scrabbling up the baking items therefrom by way of a conveyor cloth.

In accordance with a practical configuration of the first coupling device it includes an entrainment member which is guided in a drive rail arranged in the pull-out direction and is height-adjustable for coupling and uncoupling a pull-out hearth. With such an entrainment member the trans-port mechanism can be connected to a pull-out hearth by way of an opening is on a pull-out hearth, in a simple and reliable fashion.

Alternatively or supplemental to the described possible option of moving the baking item receiving surface in the direction of the baking surface, overlapping of the baking item receiving surface and the baking surface can also be effected by a pull-out hearth arranged on the carrier elements of the pull-out frame being conveyed on to the treatment table and thus being drawn directly under the baking item receiving surface. That can be effected for example by a second transport mechanism with a second coupling device being provided on the treatment table.

In that case however coupling operations with the first and second coupling devices are required for the feed procedure. In a practical embodiment the first coupling device and the second coupling device are coupled together in such a way that in the unloading operation uncoupling by the first coupling device is only possible if the second coupling device has already coupled and in the loading operation uncoupling by the second coupling device is only possible if the first coupling device has already uncoupled. That ensures that a pull-out hearth is reliably ‘transferred’ from the first to the second coupling device or from the second to the first coupling device respectively.

Monitoring of the transfer of a pull-out hearth from the first coupling device to the second coupling device and vice-versa is particularly reliable if the control unit is adapted to control the operating condition of the baking item receiving surface in dependence on the operating condition of the second transport mechanism.

If the pull-out frame and/or the baking item receiving surface and/or the treatment table and/or the entire feed installation is displaceable laterally, that is to say transversely relative to the pull-out direction, the variability of the feed apparatus is increased, whereby a multiplicity of feed and other treatment operations can be carried out even on a very small space in a short time. Means for displacement of the entire feed installation can be for example transport rails which are let into the floor and along which the feed installation can be laterally displaced by way of rollers.

The invention also provides methods according to the invention of feeding a multi-tier baking oven with feed apparatuses according to the invention. Attention is hereby directed to the advantages which have been described hereinbefore in connection with the feed installation according to the invention and which also apply to the methods according to the invention.

Individual embodiments are described hereinafter with reference to the drawings in which:

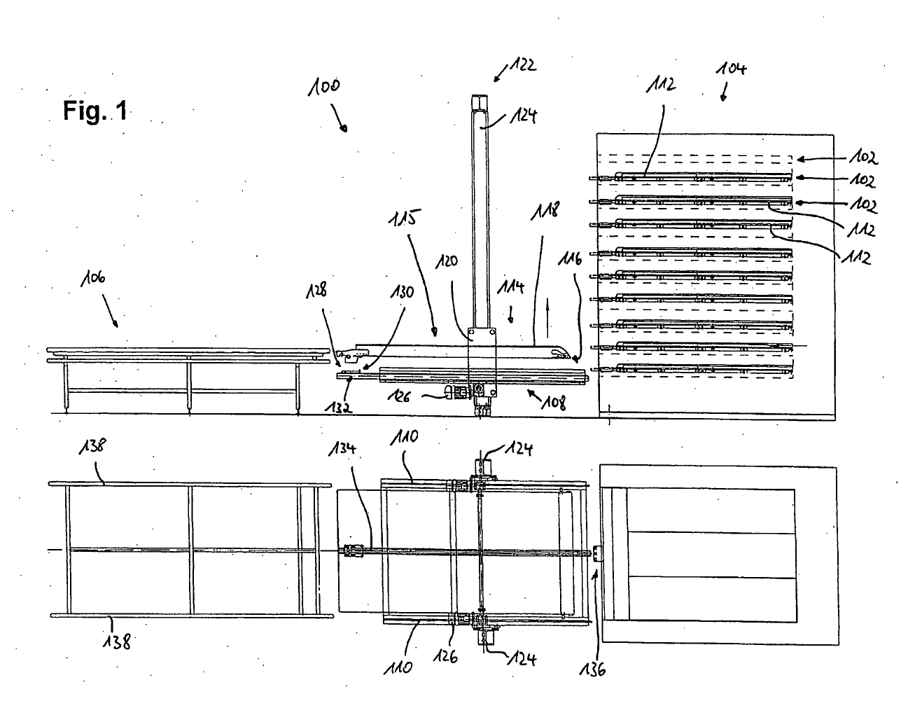

FIGS. 1-6 show a first embodiment of a feed installation according to the invention in various operating conditions.

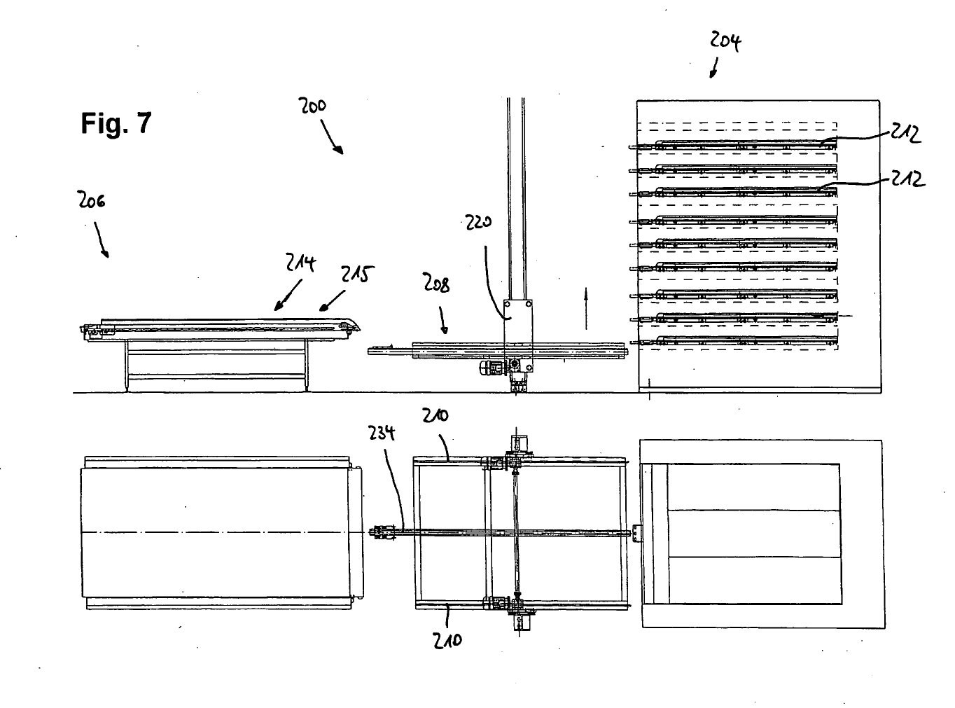

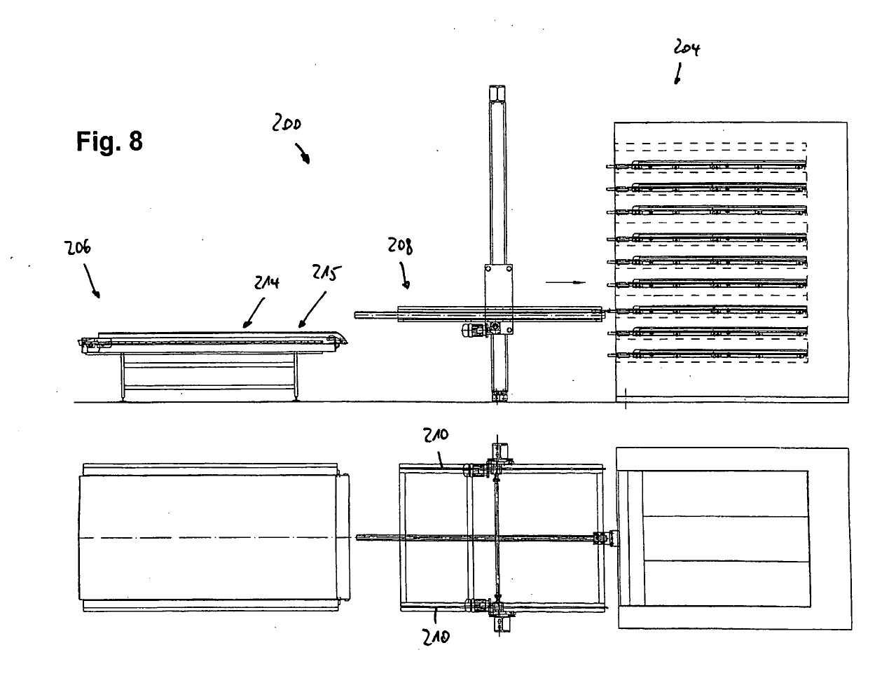

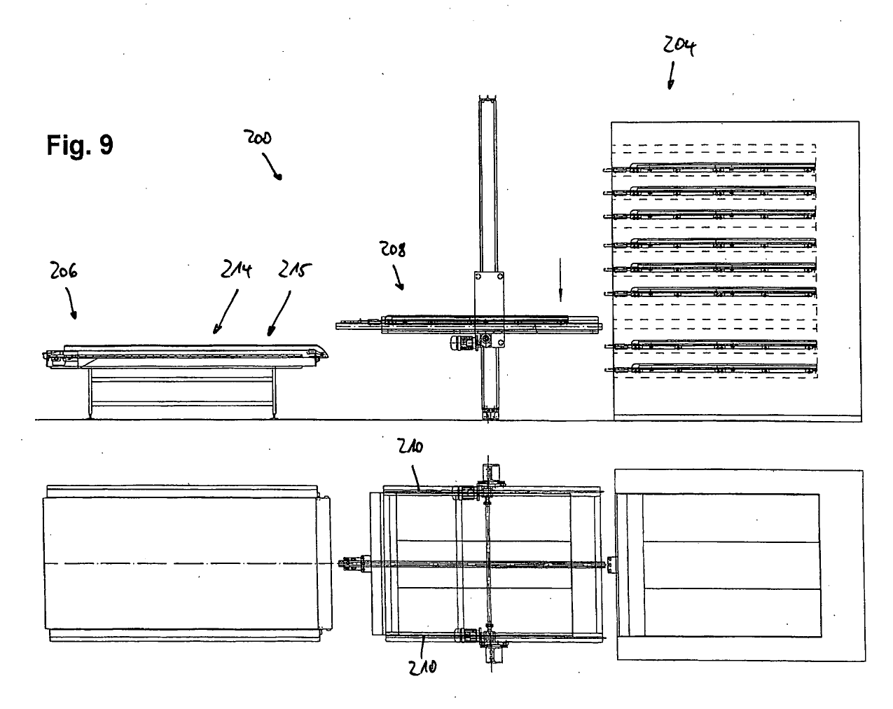

FIGS. 7-10 show a second embodiment of a feed installation according to the invention in various operating conditions, and

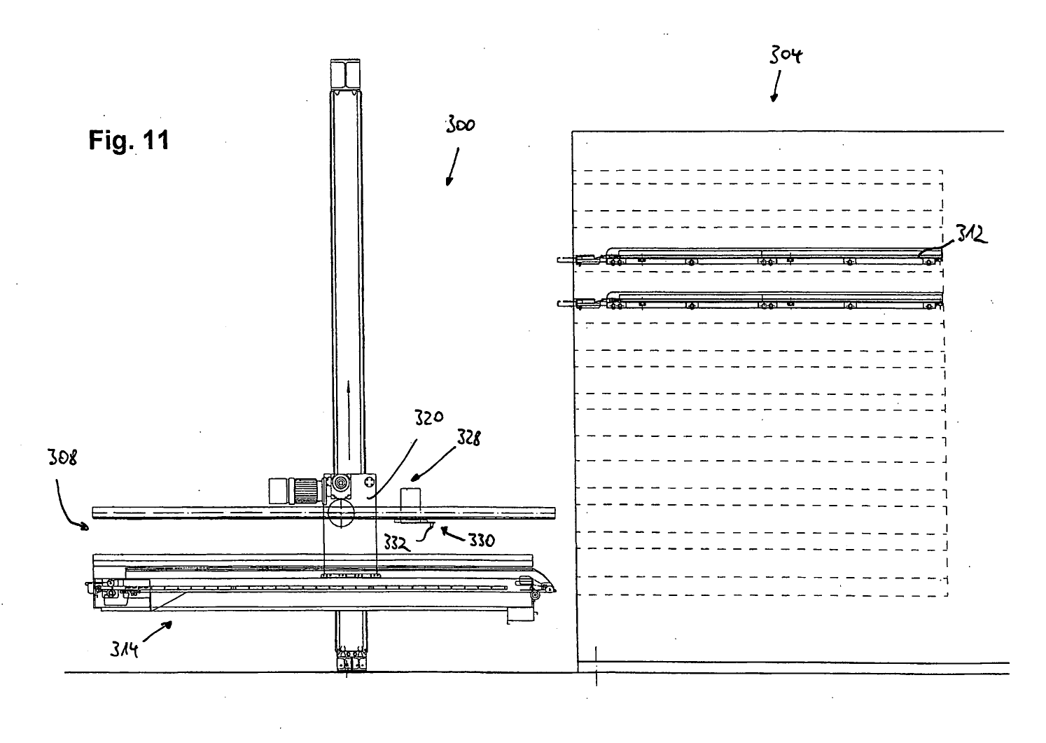

FIGS. 11-24 show a third embodiment of a feed installation according to the invention in various operating conditions.

FIGS. 1 to 6 show a first embodiment of a feed installation 100 according to the invention, which is arranged in front of a multi-tier baking oven 104 having a plurality of hearths 102. Arranged in front of the feed installation 100 is a treatment table 106 on which dough pieces or finished baked items can be kept in intermediate storage and processed.

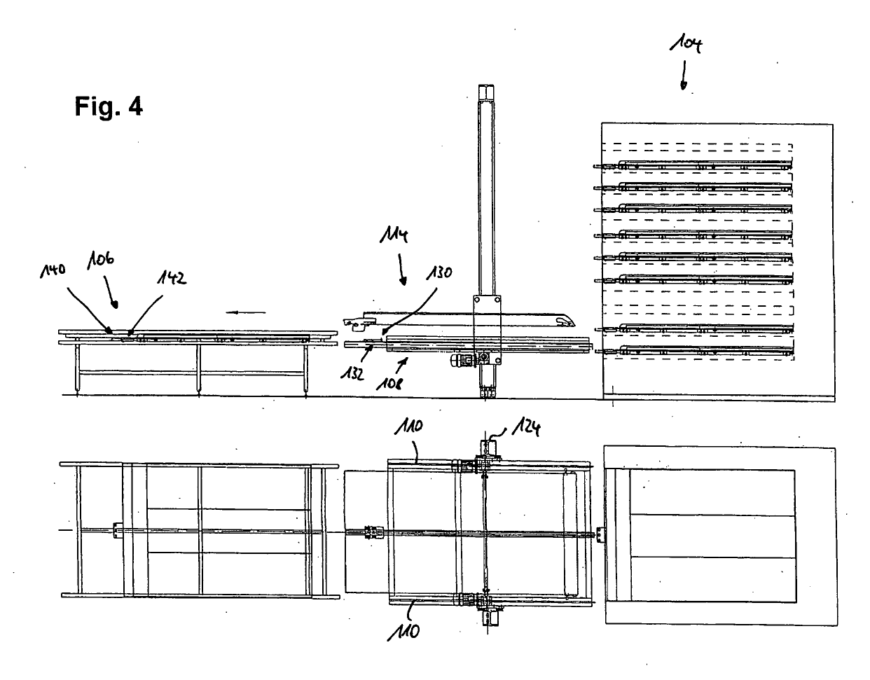

The feed installation 100 includes a pull-out or extendable frame 108 having carrier elements 110 for receiving and supporting pull-out hearths 112 which can be pulled out of the hearths 102 of the multi-tier baking oven 104, as shown in FIG. 4. As can be seen from the Figures the carrier elements 110 are preferably lateral running rails, on which rollers arranged on pull-out hearths 112 are guided and can be supported. Corresponding rails are preferably arranged in the multi-tier baking oven 104 (indicated in the Figures by broken lines).

The feed installation further includes a baking item receiving device 114 having a baking item receiving surface 115 formed by a conveyor cloth 118 guided around a direction-changing edge 116. The conveyor cloth 118 is drivable in particular for receiving baking items from a pull-out hearth 112 or for depositing baking items on a pull-out hearth 112.

The pull-out frame 108 and the baking item receiving device 114 are arranged on a common lift axis 122 by way of a common displacement unit 120. The lift axis includes two vertically arranged guide pillars 124 into which the displacement unit 120 engages. As can be seen from FIGS. 1 to 4 the displacement unit 120 is adjustable in respect of height as a whole along the lift axis 122. A drive motor 126 is provided for that purpose.

The pull-out frame 108 is rigidly connected to the displacement unit 120. Besides the carrier elements 110 it includes a transport mechanism 128 having a first coupling device 130. The first coupling device 130 includes an entrainment member 132 which is guided in a drive rail 134 extending in the pull-out direction of the pull-out hearth 112.

The baking item receiving device 114 is height-adjustably connected to the displacement unit 120, as can be seen from FIGS. 4 to 6. Height adjustment is effected by way of an electric, mechanical or hydraulic drive and provides that the pull-out frame 108 and the baking item receiving device 114 can be moved towards each other or away from each other.

FIGS. 1 to 6 show two possible ways in which, with the first embodiment of the feed installation 100 according to the invention, baking items (not shown) arranged on a pull-out hearth 112 (here by way of example the third pull-out hearth from the bottom) can be removed from the multi-tier baking oven 104.

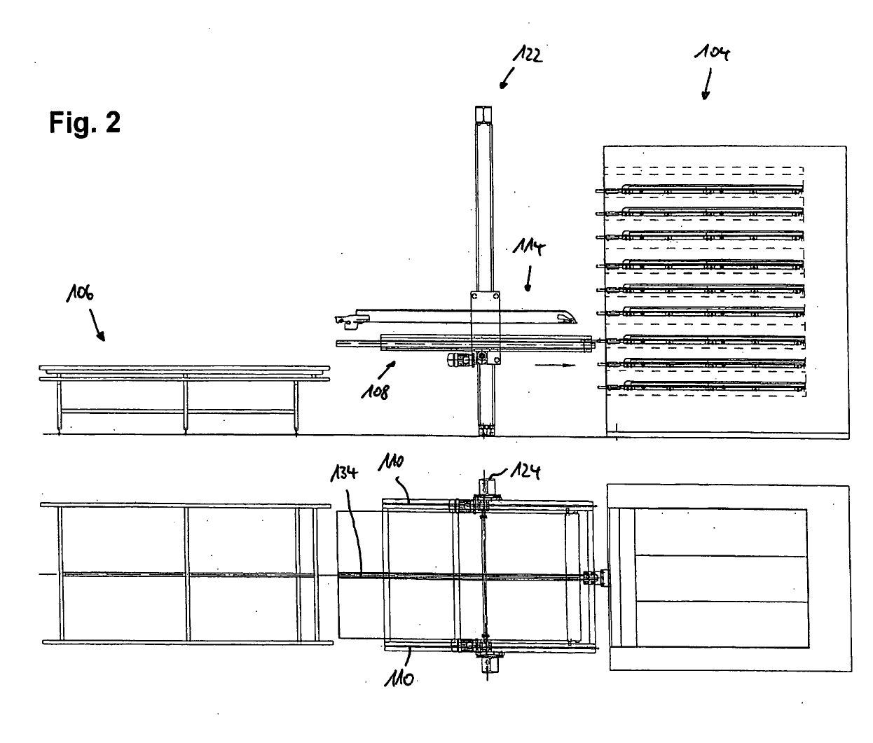

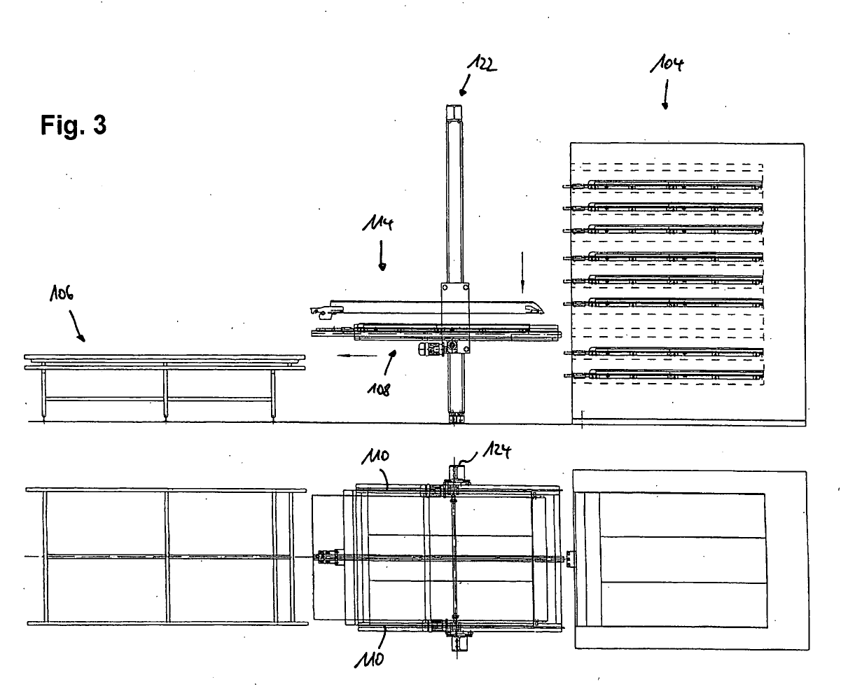

FIGS. 1 to 4 show the transfer of a pull-out hearth 112 from the multi-tier baking oven 104 on to the treatment table 106. As shown in FIG. 2 for that purpose firstly the displacement unit 120 is displaced in such a way that the carrier elements 111 are aligned with the corresponding carrier elements in the multi-tier baking oven 104. In addition the transport mechanism 128 is displaced in the direction of the multi-tier baking oven 104 so that the first coupling device 130 can engage into a coupling element 136 of the pull-out hearth 112 and thus couple therewith. After coupling the trans-port mechanism 128 is moved back into its starting position whereby the pull-out hearth 112 is pulled on to the carrier elements 110 of the pull-out frame 108 (see FIG. 3). The displacement unit is then lowered until the carrier elements 110 are arranged at the same height as the corresponding carrier elements 138 of the treatment table 106. A second transport mechanism which is arranged on the treatment table 106 and which has a second coupling device 142 is displaced to the coupling element 136 of the pull-out hearth 112 and couples therewith. After conclusion of the coupling operation for the second coupling device 142 the first coupling device 130 is uncoupled so that, as shown in FIG. 4, the pull-out hearth 112 can be pulled by the second transport mechanism 140 from the carrier elements 110 of the feed installation 100 on to the carrier elements 138 of the treatment table 106.

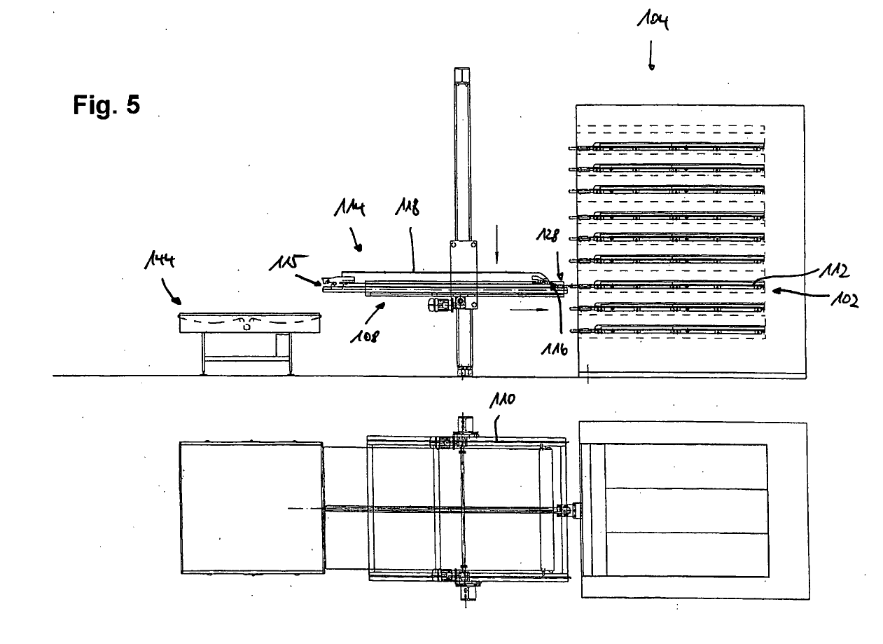

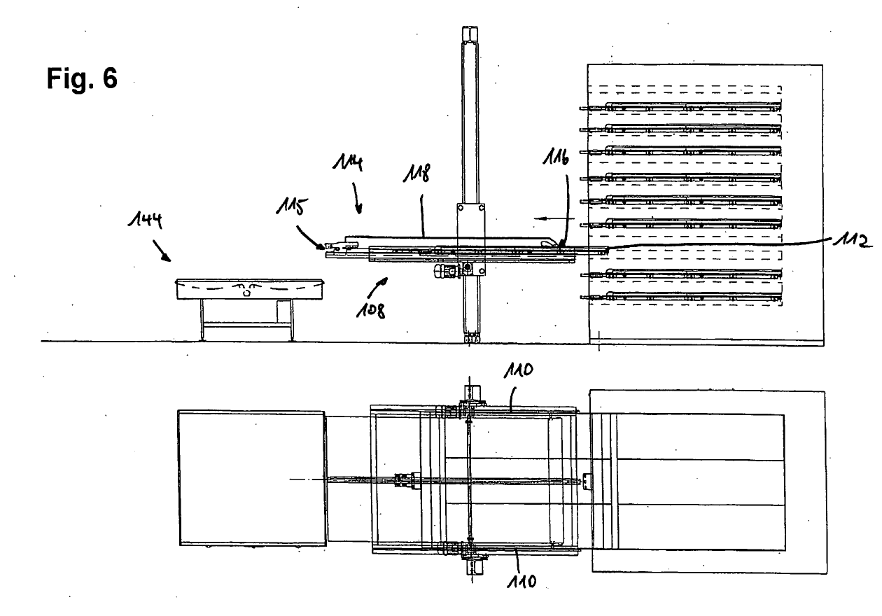

FIGS. 5 and 6 show how freely pushed baking items arranged on a pull-out hearth 112 can be introduced into the multi-tier baking oven 102 with the feed installation 100 according to the invention, and removed from the multi-tier baking oven 102. In this case, as shown in FIGS. 5 and 6, the treatment table 106 can be replaced by a conveyor belt 144.

To remove freely pushed baking items arranged on a pull-out hearth 112 from the pull-out hearth 112 with a feed installation according to the invention, firstly the steps described with reference to FIGS. 1 and 2 are carried out. Before the pull-out hearth 112 is pulled out by means of the first transport mechanism 128 the baking item receiving device 114 is moved towards the carrier elements 110 of the pull-out frame 108 to such an extent that the pull-out hearth 112 can be pushed along under the baking item receiving surface 115, with or without a slight clearance (see FIG. 5). Then the pull-out hearth 112 is pulled out of the multi-tier baking oven 104 on to the carrier rails 110 of the pull-out frame 106 by means of the first transport mechanism. At the same time the conveyor cloth 118 is driven at the same speed as the transport mechanism so that all baking items on the pull-out hearth 112 are engaged by the conveyor cloth at the direction-changing edge 116 which bears under a light pressure against the baking surface of the pull-out hearth 112, and are thereby conveyed from the baking hearth 112 on to the baking item receiving surface 115 (see FIG. 6). That has the advantage that freely displaced baking items can be removed outside the hearth 102, thereby ensuring that baking items which drop down do not remain behind in the hearth 102. If it should not be possible for individual baking items to be gripped by the conveyor cloth 118 which is outside the oven, there is no danger that they remain behind in the multi-tier baking oven and are charred therein. In addition auxiliary means is can be provided to ensure that baking items are reliably received.

It is also to be noted that the baking item receiving surface 115 with the conveyor cloth 118 is always outside the baking oven and accordingly does not have to be adapted in respect of its structural height and width to the opening of the oven. In addition there can be provided a device which, after removal of the baking items from the baking surface, removes dirt and soiling from the baking surface. That device can be for example a brush or a scraper (stripping-off bar).

The second embodiment (FIGS. 7 to 10) and the third embodiment (FIGS. 11 to 24) of the feed installation according to the invention are described hereinafter. For the sake of easier comprehension therefore, components corresponding to the components of the first embodiment are denoted by references which are increased by 100 and 200 respectively with respect to those used in FIGS. 1 to 6.

The second embodiment of a feed installation 200 according to the invention as shown in FIGS. 7 to 10 substantially differs from the first embodiment in that the baking item receiving surface 215 is a constituent part of the treatment table 206. Therefore only the pull-out frame 208 with the carrier elements 210 is arranged on the displacement unit 220.

The transfer of the pull-out hearth 212 out of the multi-tier baking oven 204 on to the treatment table 206 with the second embodiment of the feed installation 202 is effected in the same manner as with the first embodiment of the feed installation 100 (see FIGS. 1 to 4).

FIGS. 7 to 10 show how freely pushed baking items arranged on a pull-out hearth 212 can be removed from the multi-tier baking oven 204 with the second embodiment of the feed installation according to the invention.

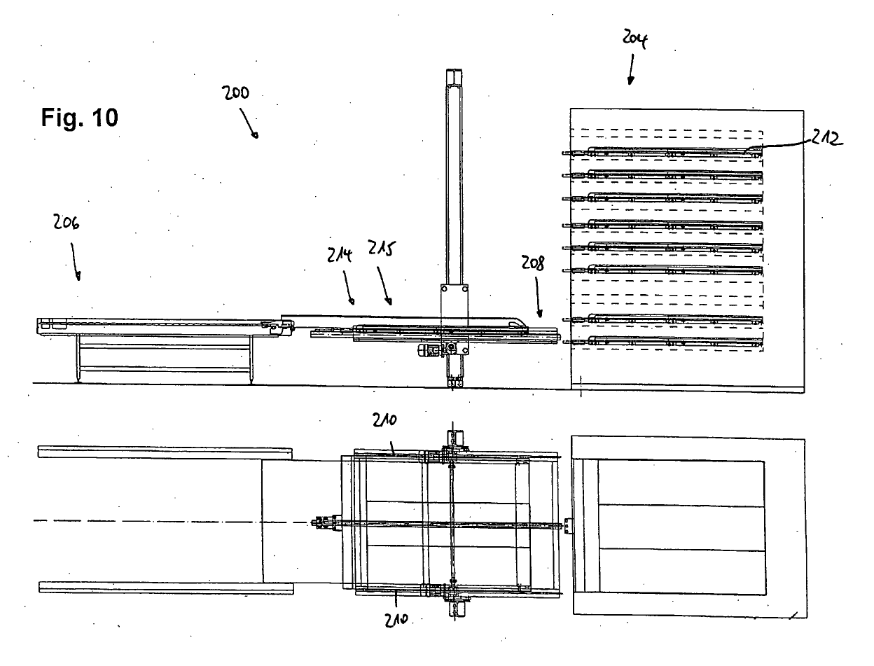

As shown in FIGS. 7 to 9, firstly the same method steps are carried out as have already been described with reference to FIGS. 1 to 3. In other words the pull-out hearth 212 to be unloaded is pulled out of the multi-tier baking oven 204 on to the carrier elements 210 of the pull-out frame 208 by means of the displacement unit 220 and the pull-out frame. The displacement unit 220 is then displaced in such a way that it is possible for the baking item receiving device 214 to move horizontally so that the baking item receiving surface 215 is pushed over the surface of the pull-out frame 208. The height of the displacement unit 220 is so adjusted in that case that the baking surface of the pull-out hearth 212 arranged on the carrier elements 210 is arranged in directly adjoining relationship beneath the baking item receiving surface to be displaced horizontally, as shown in FIG. 10.

Then, as illustrated in FIG. 10, the baking item receiving device 214 is displaced horizontally in the direction of the pull-out frame 208. The conveyor cloth 218 is driven at the same speed as the baking item receiving device 214 but in the opposite direction. Baking items which are disposed on the baking surface of the pull-out hearth 212 arranged on the carrier elements 210 of the pull-out frame 208 and which bear against the direction-changing edge 216 of the conveyor cloth are picked up by the conveyor cloth. That form of baking item pick-up reception is also referred to in the terminology in the art as scrabbling up. By virtue of the fact that the conveyor cloth 218 and the baking item receiving device 214 are driven at the same speed but in opposite directions means that the scrabbled-up baking items are not displaced substantially in a horizontal direction but are scrabbled up during the scrabbling-up operation substantially from the baking surface of the pull-out hearth 212 on to the conveyor cloth. As soon as the overlap of the baking item receiving device 214 and the baking surface of the pull-out hearth 212 is complete and the baking surface has reached the extreme position shown in FIG. 10 the drive of the conveyor cloth and the baking item receiving device 224 is stopped. The baking items in that position are completely scrabbled up from the baking surface of the pull-out hearth 212 on to the conveyor cloth. Therefore, the baking item receiving device is displaced horizontally into the FIG. 7 position, with the conveyor cloth 218 stationary, with the baking items received thereon. The baking items can be removed from the FIG. 7 position, subjected to further processing and/or further conveyed by way of the conveyor cloth to other treatment devices, for example freezer or packaging installations.

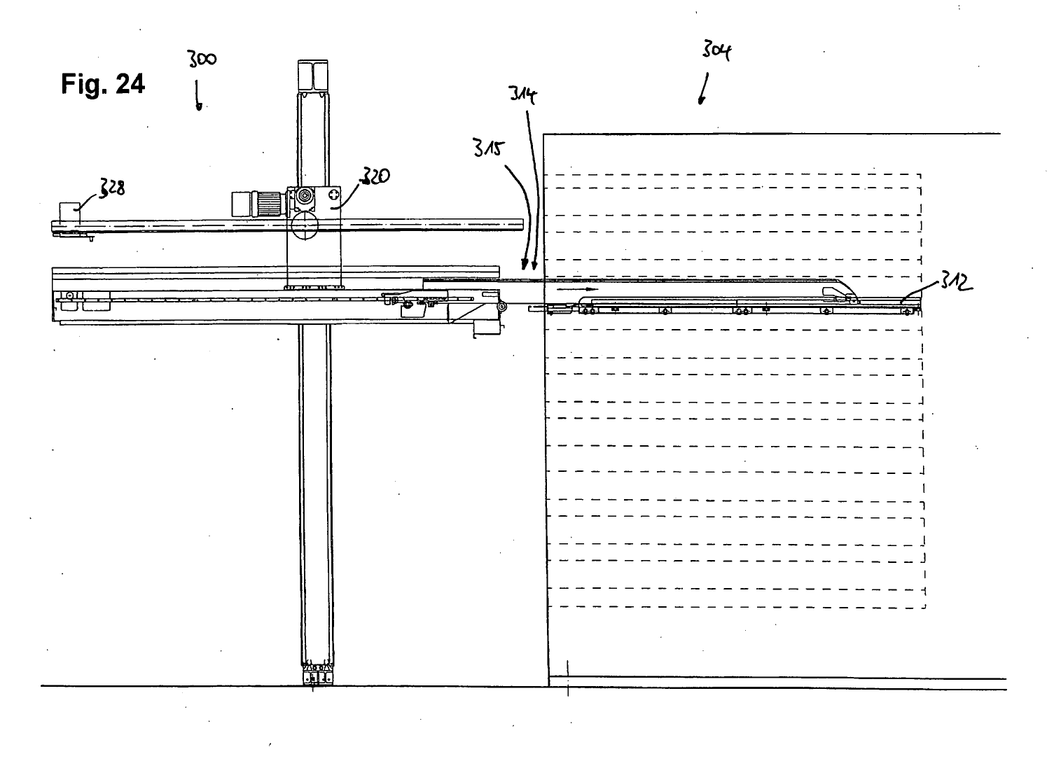

FIGS. 11 to 24 show a third embodiment of the feed installation 300 according to the invention. With this embodiment of the feed installation 300 according to the invention, in a first mode of operation, pull-out hearths 312 can be conveyed out of a multi-tier baking oven 304 on to a treatment table 306 (see FIGS. 11 to 24) and in a second mode of operation baking items can be conveyed from a baking surface in a multi-tier baking oven 304 on to a baking item receiving surface 315 (see FIG. 24).

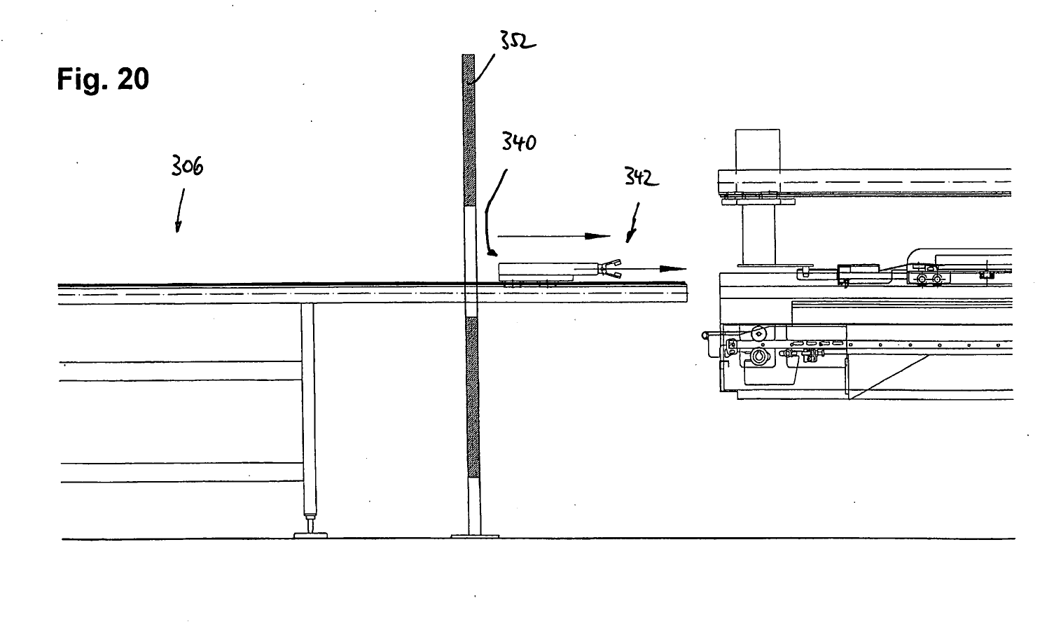

As shown in FIG. 11 the third embodiment has a baking item receiving device 314 and a pull-out frame 308 arranged thereabove. The baking item receiving device 314 and the pull-out frame 308 are rigidly connected to a displacement unit 320. The principle shown in FIGS. 11 to 24 corresponds to the principle described hereinbefore in connection with the first and second embodiments. By virtue of the enlarged and detailed views in FIGS. 11 to 24, the first transport mechanism 328 (FIGS. 11 to 24) and the second transport mechanism 340 (FIGS. 20 to 24) can be particularly clearly seen in those views.

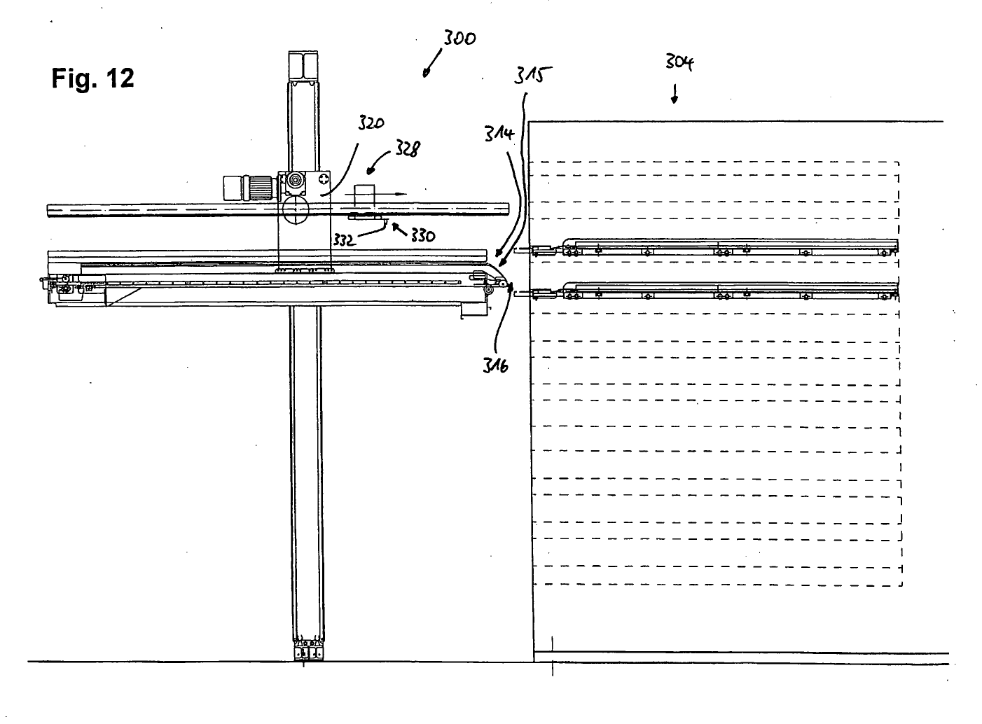

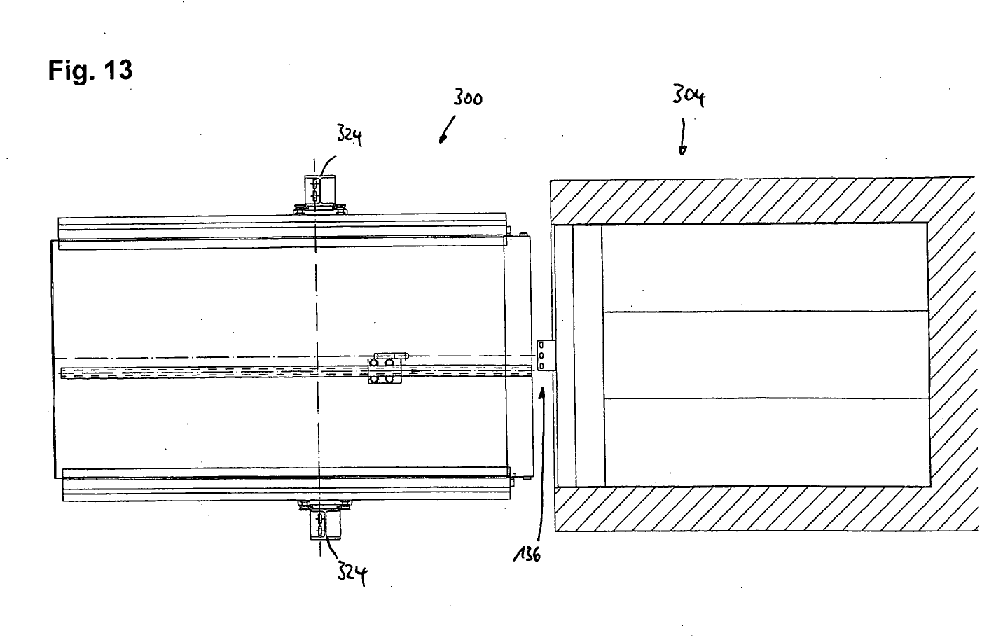

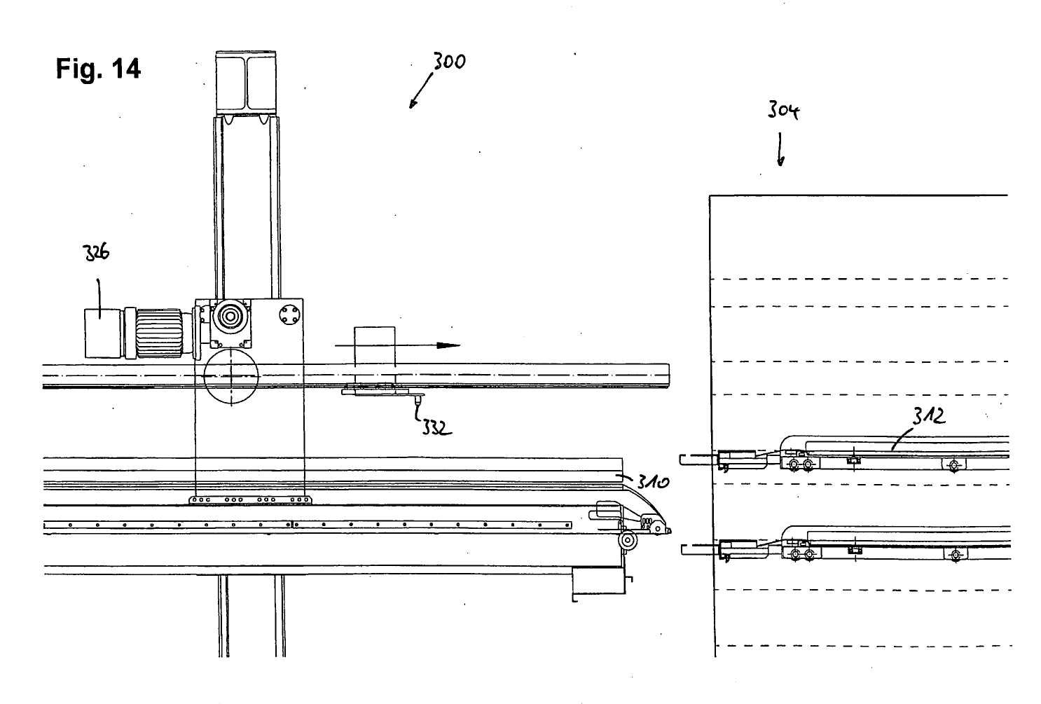

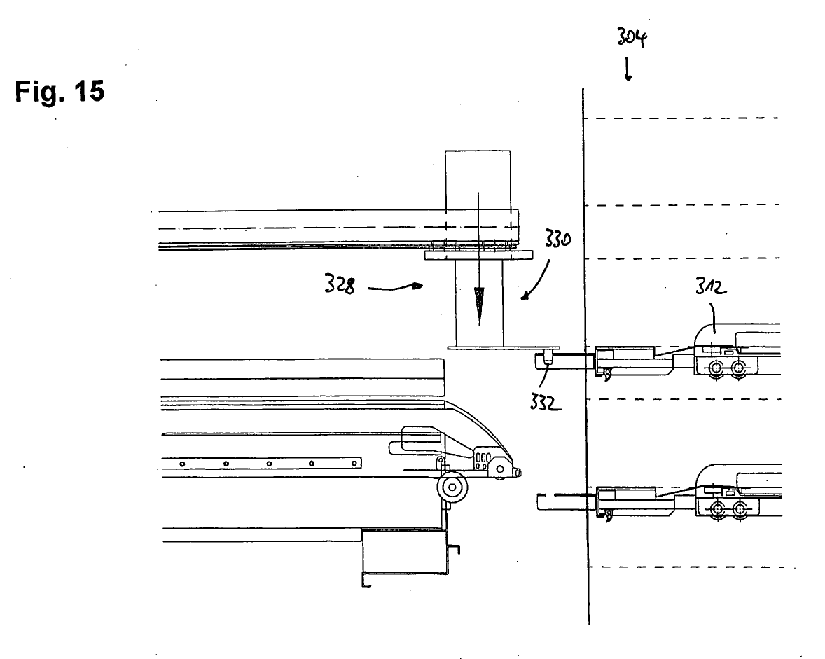

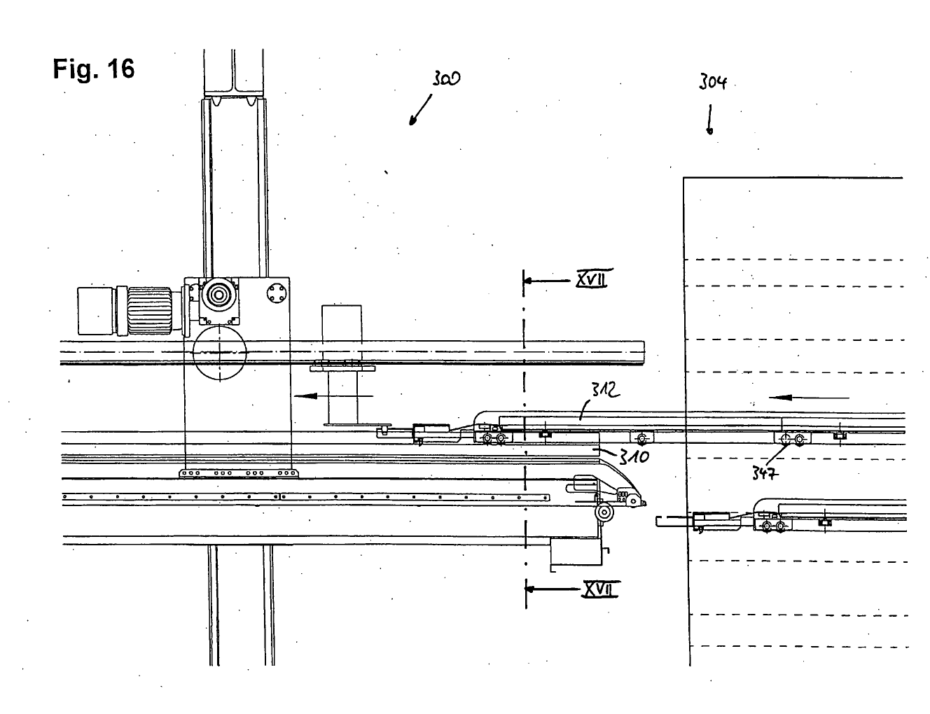

Firstly the displacement unit is displaced upwardly as indicated by the arrow in FIG. 11. Then the first transport mechanism 328 with the first coupling device 330 is displaced as indicated by the arrow in FIG. 12 in the direction of the multi-tier baking oven 304. FIG. 13 shows that as a view from above, while FIG. 14 shows a view on a further enlarged scale from which in particular the entrainment member 332 can be clearly seen. The coupling device 330 is displaced until the entrainment member can engage into an opening in a coupling element provided on a pull-out hearth 312, by a downward movement, as shown in FIG. 15. Then the entrainment member is lowered as indicated by the arrow in FIG. 15 and the first transport mechanism 328 is thus coupled to the pull-out hearth 312. Then, by a return movement of the transport mechanism 328, the pull-out hearth 312 is pulled out of the multi-tier baking oven 304 as indicated by the arrow in FIG. 16.

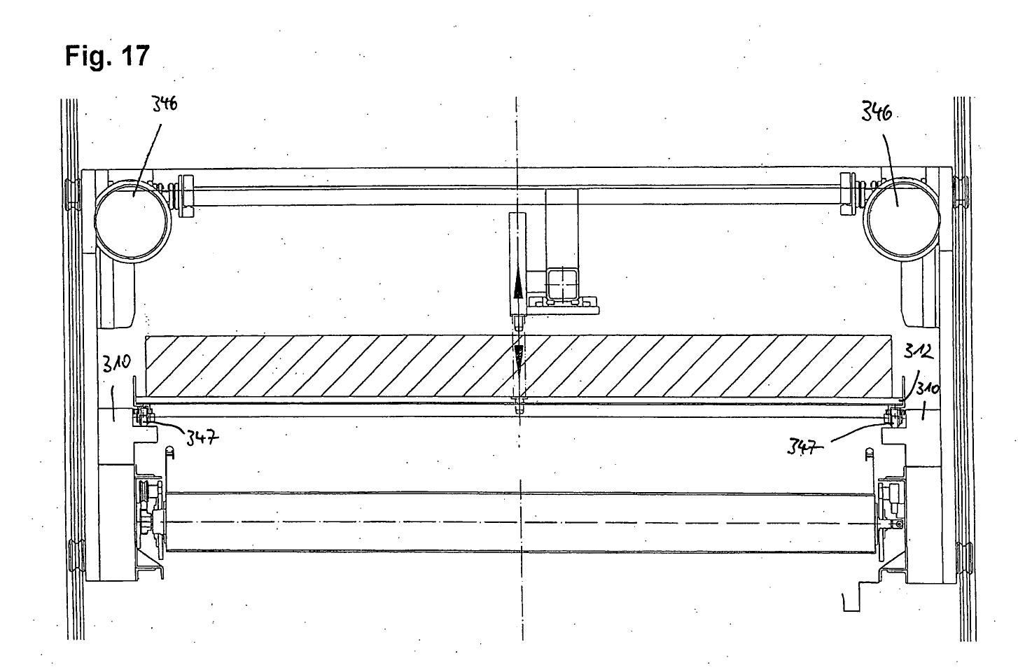

FIG. 17 shows a sectional view through a feed installation according to the invention along line XVII-XVII in FIG. 16, wherein, in comparison with the view in FIG. 16, a hatched area is illustrated as representative of baking items and wherein the transport mechanism is shown in an uncoupled condition, unlike FIG. 16. This view shows the lifting axis drive 346 and the rollers 347 of the pull-out hearth 312 shown in section.

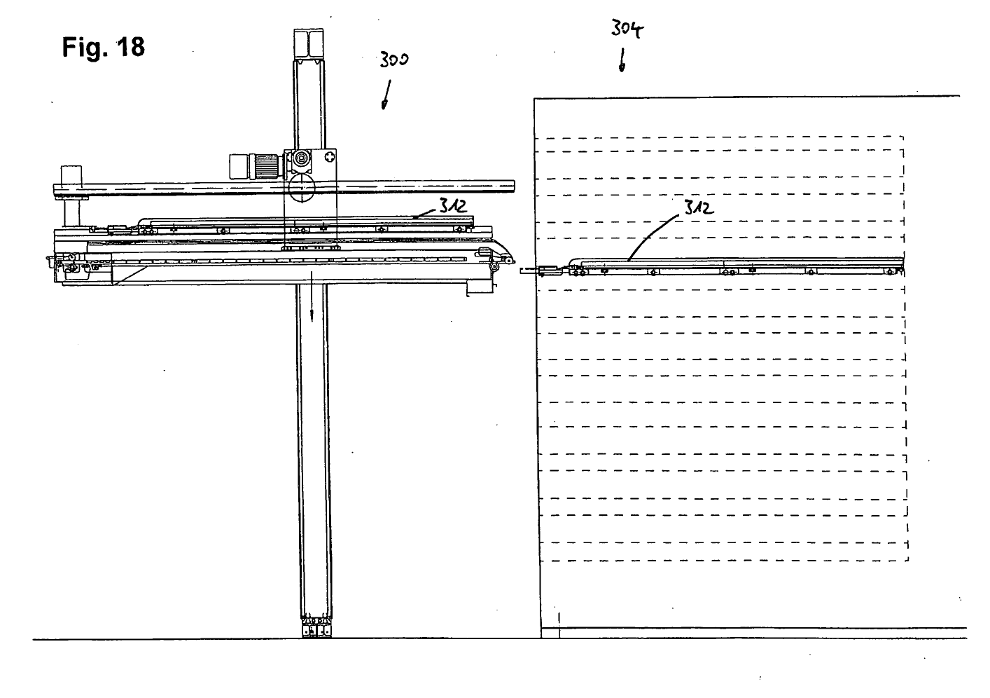

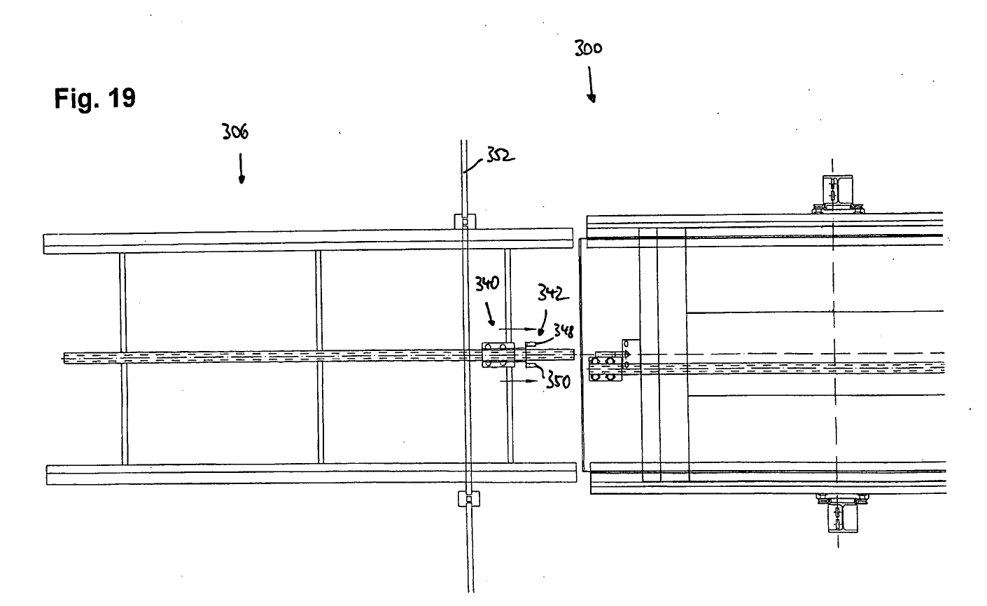

As soon as the pull-out hearth 312 is pulled completely out on to the carrier elements 310 of the pull-out frame, the displacement unit 320 is displaced downwardly as indicated by the arrow in FIG. 18 to the height of the treatment table 306 disposed therebeside (see FIG. 19).

As shown in FIGS. 19 and 20 as a view from above and in section respectively the treatment table 306 has a second transport mechanism 340 with a second coupling device 342. The second transport mechanism 340 includes a first coupling pin 348 and a second coupling pin 350. The second transport mechanism 340 is moved in the direction of the pull-out hearth 312 as indicated by the arrows in FIGS. 19 and 20 until the first and second coupling pins 348, 350 are arranged in alignment over two coupling openings in the pull-out hearth 312. Then the first coupling pin 348 and the second coupling pin 350 are lowered and the second transport mechanism 340 is thus coupled to the pull-out hearth 312.

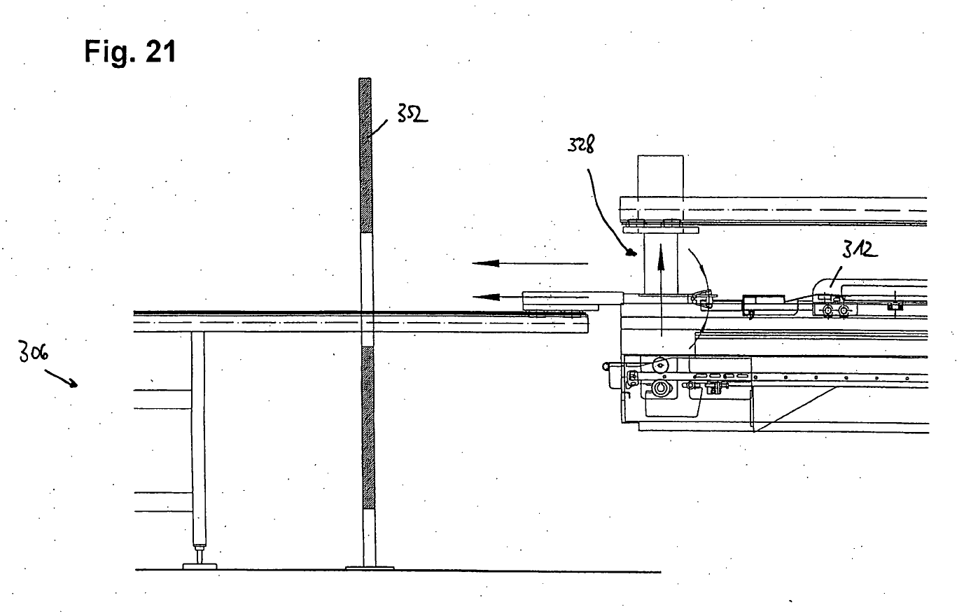

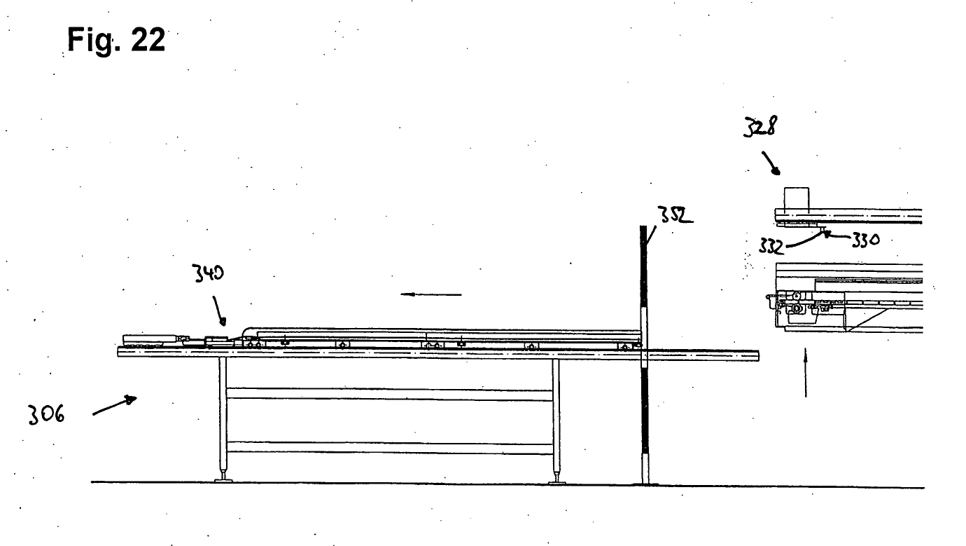

As soon as that coupling operation is concluded the entrainment member 332 of the first transport mechanism 328 is moved upwardly and thus uncoupled. After the conclusion of those coupling operations the second transport mechanism 340 is moved back in the direction of the treatment table 306 as indicated by the arrows in FIGS. 21 and 22, through the closure member 352 shown in section, until the pull-out hearth 312 is pulled completely on to the treatment table 306. As soon as that is the case the baking item receiving device can be moved again upwardly freely along the lifting axis, as indicated by the arrow upwardly in FIG. 22, for example to pull a further pull-out hearth 312 out of the multi-tier baking oven 304.

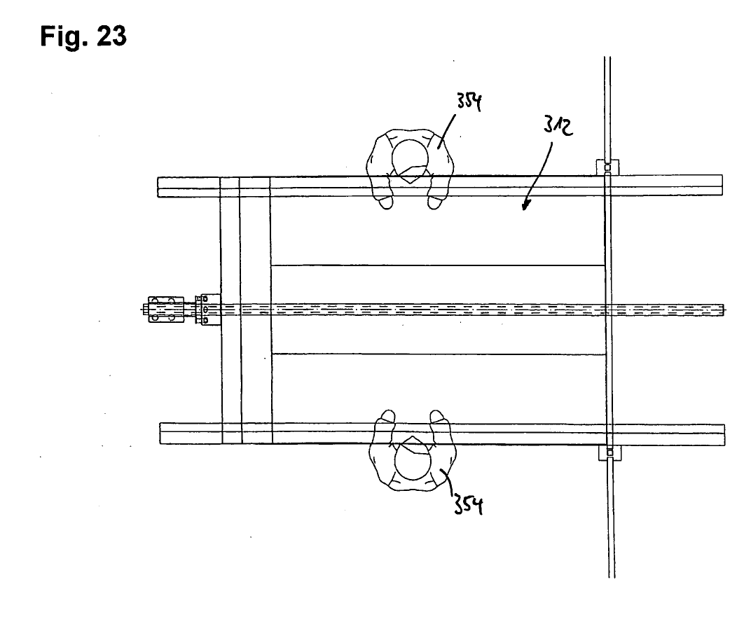

As shown in FIG. 23, the pull-out hearth 312 which has been pulled by the second transport device through the closure member 352 on to the treatment table 306 is now freely accessible for operators 354 moving to the treatment table 306 at the sides thereof.

FIG. 24 shows the third embodiment of the feed installation 300 according to the invention while the baking item receiving device 314 is moved horizontally into a hearth 302 of the multi-tier baking oven 304 to receive baking items from the baking surface of a pull-out hearth 312. The baking items are received in the same manner as already described with reference to FIG. 10.

### LIST OF REFERENCES

100, 200, 300 feed installation
102, 202, 302 hearths
104, 204, 304 multi-tier baking oven
106, 206, 306 treatment table
108, 208, 308 pull-out frame
110, 210, 310 carrier elements
112, 212, 312 pull-out hearths
114, 214, 314 baking item receiving device
115, 215, 315 baking item receiving surface
116, 216, 316 direction-changing edge
118, 218, 318 conveyor cloth
120, 220, 320 displacement unit
122, 222, 322 lift axis
124, 224, 324 guide pillars
126, 226, 326 drive motor
128, 228, 328 first transport mechanism
130, 230, 330 first coupling device
132, 232, 332 entrainment member
134, 234, 334 drive rail
136, 236, 336 coupling element
138, 238, 338 carrier elements of the treatment table
140, 240, 340 second transport mechanism
142, 242, 342 second coupling device
144, 244, 344 transport belt
346 lifting axis drive
347 rollers
348 first coupling pins
350 second coupling pin
352 closure member
354 operator

1. A feed installation for arrangement in front of at least one multi-tier baking oven having a plurality of hearths with baking surfaces, wherein at least one hearth is in the form of a pull-out hearth which can be pulled out in a pull-out direction, the feed installation comprising:
a pull-out frame with carrier elements for receiving and supporting the pull-out hearth; and
a baking item receiving device having a baking item receiving surface receiving baking items arranged on a baking surface, wherein the baking item receiving surface is movable relative to the baking surface.

2. The feed installation according to claim 1, wherein the pull-out frame has a first transport mechanism with a first coupling device, and wherein the first transport mechanism conveys a pull-out hearth out of a hearth of the multi-tier baking oven on to the carrier elements.

3. The feed installation according to claim 1, wherein the pull-out frame and the baking item receiving surface are displaceable in respect of height.

4. The feed installation according to claim 1, further comprising:
a control unit that monitors and controls an operating condition of the pull-out frame and an operating condition of the baking item receiving surface.

5. The feed installation according to claim 1, wherein the baking item receiving surface is formed by a conveyor cloth which is guided around at least one direction-changing edge extending transversely with respect to the pull-out direction, and which is drivable.

6. The feed installation according to claim 1, wherein the pull-out frame and the baking item receiving surface are both mounted on a common lift axis.

7. The feed installation according to claim 6, wherein the pull-out frame and the baking item receiving surface are mounted to a common height-adjustable displacement unit of the lift axis.

8. The feed installation according to claim 6, wherein the pull-out frame and the baking item receiving surface are mounted to two separate displacement units of the lift axis.

9. The feed installation according to claim 1, wherein the pull-out frame and the baking item receiving surface are height-adjustable relative to each other.

10. The feed installation according to claim 4, wherein the control unit controls the operating condition of the baking item receiving surface in dependence on the operating condition of the pull-out frame.

11. The feed installation according to claim 1, wherein the baking item receiving surface is part of a treatment table arranged spatially beside the pull-out frame.

12. The feed installation according to claim 11, wherein the treatment table displaces the baking item receiving surface in the pull-out direction in such a way that the baking item receiving surface and a surface of the pull-out frame are at least partially arranged one over the other.

13. The feed installation according to claim 12, wherein the pull-out frame includes a first transport mechanism having a first coupling device, and wherein the first coupling device includes an entrainment member which is guided in a drive rail arranged in the pull-out direction and is height-adjustable for coupling and uncoupling the pull-out hearth.

14. The feed installation according to claim 13, wherein the treatment table has a second transport mechanism with a second coupling device which conveys the pull-out hearth conveyed by the first transport mechanism on to the carrier elements from the pull-out frame on to the treatment table.

15. The feed installation according to claim 14, wherein the first coupling device and the second coupling device are coupled together in such a way that, in an unloading operation, uncoupling by the first coupling device is only possible if the second coupling device has already coupled and in such a way that, in a loading operation, uncoupling by the second coupling device is only possible if the first coupling device has already coupled.

16. The feed installation according to claim 14, wherein further comprising:
a control unit that monitors and controls an operating condition of the second transport mechanism and an operating condition of the baking item receiving surface, wherein the control unit controls the operating condition of the baking item receiving surface in dependence on the operating condition of the second transport mechanism.

17. The feed installation according to claim 1, wherein at least one of the following elements is displaceable transversely to the pull-out direction: the pull-out frame, the baking item receiving surface, a treatment table, and the entire feed installation.

18. A method of feeding at least one multi-tier baking oven having baking surfaces arranged on pull-out hearths with baking items using a feed installation, the method comprising:
arranging the baking items on a baking item receiving surface of the feed installation, wherein the baking item receiving surface is arranged above a pull-out hearth arranged on carrier elements of a pull-out frame of the feed installation;
displacing the carrier elements in height until a pull-out hearth to be fed is displaceable out of a hearth of the multi-tier baking oven on to the carrier elements;
displacing the baking item receiving surface and the pullout pull-out frame in height relative to each other until an edge of the baking item receiving surface is above a baking surface of the pull-out hearth;
displacing the baking item receiving surface and the baking surface of the pull-out hearth relative to each other in such a way that the baking items are deposited from the baking item receiving surface on to the baking surface of the pull-out hearth, wherein displacing the baking item receiving surface and the baking surface of the pull-out hearth includes displacing the pull-out hearth resting on the carrier elements towards the multi-tier baking oven.

19. A method of feeding at least one multi-tier baking oven having baking surfaces arranged on pull-out hearths with baking items using a feed installation, the method comprising:
arranging the baking items on a baking item receiving surface of the feed installation, wherein the baking item receiving surface is arranged beside a baking surface of a pull-out hearth that is arranged on carrier elements of a pull-out frame of the feed installation;
displacing the pull-out frame along a lift axis until an edge of the baking item receiving surface is above the baking surface of the pull-out hearth; and
displacing the baking item receiving surface and the baking surface of the pull-out hearth relative to each other in such a way that the baking items are deposited from the baking item receiving surface on to the baking surface of the pull-out hearth.

20. The method according to claim 19, wherein the pull-out hearth is displaced from the carrier elements of the pull-out frame on to a carrier frame arranged beneath the baking item receiving surface and then back again on to the carrier elements, and wherein, during the displacement on to the carrier elements the baking items are deposited from the baking item receiving surface on to the baking surface of the pull-out hearth.

21. The method according to claim 19, wherein the baking item receiving surface is displaced horizontally in the direction of the pull-out hearth arranged on the carrier elements until the baking item receiving surface is above the baking surface of the pull-out hearth and is then moved back again in the opposite direction into the original position, wherein the baking items are deposited from the baking item receiving surface on the baking surface of the pullout hearth.

22. The method according to claim 18, wherein the baking item receiving surface used is a conveyor cloth which is guided around at least one direction-changing edge extending transversely to the direction of displacement of the pull-out hearth, which cloth is drivable for conveying the baking items from the baking item receiving surface on to the baking surface of the pull-out hearth in relation to the baking item receiving surface.

23. The method according to claim 19, wherein the baking item receiving surface is a conveyor cloth which is guided around at least one direction-changing edge extending transversely to the direction of displacement of the pull-out hearth, which cloth is drivable for conveying the baking items from the baking item receiving surface on to the baking surface of the pull-out hearth in relation to the baking item receiving surface.
